(19) United States
(12) Patent Application Publication
(10) Pub. No.: US 2008/0170577 A1
(43) Pub. Date: Jul. 17, 2008

(54) Station Device, Message Transfer Method, and Program Storage Medium Storing Program Thereof

(75) Inventors: Takeshi Sumou, Fukuoka (JP); Yoshiyuki Karakawa, Fukuoka (JP); Kousuke Nakamura, Fukuoka (JP); Katsumi Imamura, Fukuoka (JP); Junichi Kawaguchi, Fukuoka (JP); Hideyo Fukunaga, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/971,379

(22) Filed: Jan. 9, 2008

(30) Foreign Application Priority Data
Jan. 11, 2007 (JP) 2007-003871

(51) Int. Cl. H04L 12/56

(52) U.S. Cl. 370/400

(57) ABSTRACT

An Ethernet frame nester nests Ethernet frames addressed to a plurality of remote station devices affiliated with a shared station device on the basis of the correspondence relation between a MAC address of the station device and MAC addresses of the remote station devices stored in a table and the transmission destination addresses of the Ethernet frames. The Ethernet frame nester then converts them into an RPR frame. When receiving an RPR frame addressed to the own station device, an Ethernet frame extractor extracts Ethernet frames from the RPR frame and transmits each Ethernet frame to the addressed remote station devices.

### BACKGROUND OF THE INVENTION

1. Field of the Invention

The present invention relates to a station device and frame transfer method for an RPR network.

2. Description of the Related Art

In an RPR (Resilient Packet Ring), a plurality of frame transfer devices called stations are connected in a ring shape. A plurality of frame transfer devices called remote stations are affiliated with a station. A station converts an Ethernet (registered trademark) frame received from a remote station into an RPR frame, and further, performs mapping to a GFP (Generic Framing Procedure) frame when the RPR ring is configured with SONET/SDH (Synchronous Optical Network/Synchronous Digital Hierarchy).

In the traditional methods, a station converts Ethernet frames received from a remote station to RPR frames one by one.

To describe with a specific example, FIG. 12A illustrates an RPR network which includes stations 10 through 70 connected in a ring shape. Remote stations 21 through 24 are affiliated with the station 20, and remote stations 61 through 64 are affiliated with the station 60.

As shown in FIG. 12B, for example, the station 20 converts an Ethernet frame 80 or an Ethernet frame 90 transmitted from the remote station 21 or the remote station 22 affiliated with the station 20 to the remote station 61 or the remote station 62 affiliated with the station 60, into an RPR frame 81 or an RPR frame 91. Note that the station 20 maps a plurality of RPR frames including the RPR frame 81 and RPR frame 91 to GFP frames in a predetermined format, and transfers the GFP frames to the station 10 since the hop number (the number of stations transited to the transfer destination station) to the station 60 is fewer in the counter-clockwise direction.

A technique is disclosed in Japanese Unexamined Patent Application Publication No. 61-33054, wherein, with a network of a plurality of node stations, each node containing a plurality of terminals, mutually connected through a transmission path, the ratio of overhead portions of a packet signal is reduced by linking all of the signal units generated from each transmission source terminal, appending a starting block to the leading edge thereof, appending a finishing block to the trailing edge thereof, and thus configuring one packet signal.

With the traditional technique described above, there has been the disadvantage of not being able to effectively use RPR network bandwidth. That is to say, as a result of appending an RPR frame header and GFP frame header to each Ethernet frame, the ratio of the RPR frame header and GFP frame header within an RPR network bandwidth (the shorter the length of the frame, the more significant the problem), the station cannot effectively use the RPR network bandwidth. With Japanese Unexamined Patent Application Publication No. 61-33054, there has been a disadvantage in that complicated processing must be performed to confirm whether all linked frames are frames transmitted with an address to the own station, and thus has been inefficient.

The disadvantage of not being able to effectively use the RPR network bandwidth, i.e., the disadvantage of the overhead of the RPR frame header and the GFP frame header not being able to effectively use the RPR network bandwidth to a greater extent when the frame length is shorter, will be described below in detail.

Under the IEEE (Institute of Electrical and Electronics Engineers) 802.17 standard, the data frame size of an RPR frame is defined as shown in FIG. 13A. In the case where the RPR ring is configured with SONET/SDH, the station converts an Ethernet frame into an RPR frame in FF1 (Basic Frame Format) shown in FIG. 13B or FF2 (Extended Frame Format) shown in FIG. 13C. The station then maps the RPR frame to a GFP frame and encloses it in an SPE (SONET/SDH Payload Envelope) shown in FIG. 13D.

Now, for example, in the case that the RPR ring is configured with STS-12c (Synchronous Transfer Signal level 12), then SONET Payload Capacity=(12*780*8)/125 μsec=599.04 Mbps.

The Ethernet capacity which is a maximum Rate value possible for input to an Ethernet frame, is capacity excluding the above-mentioned RPR frame header, GFP frame header, and FCS (frame check sequence) which is selectable whether to insert or not insert, as to the SONET Payload Capacity, and therefore, for example, to calculate the Ethernet capacity of an Ethernet frame which has “frame length 64 Bytes”, “FF1 (Basic Frame Format)”, “no FCS of GFP”, this results in 599.04*64/(64+6+8)=491.52 Mbps. Note that the 6 in the expression is the RPR frame header length in FF1, and the 8 is the GFP frame header length.

By computing the Ethernet capacity of other Ethernet frames by increasing the frame length thereof by 64 Bytes, the results shown in FIG. 13E are obtained. Then taking the difference of the Ethernet capacity of each Ethernet frame and the Ethernet capacity of the Ethernet frame with a length of 9198 Bytes (see FIG. 13F), and finding the loss rate of each Ethernet frame when the loss rate of the Ethernet frame with a length of 9198 Bytes is 0% (see FIG. 13G), the Ethernet frame with a length of 64 Bytes have a loss rate of 32% at most. 9198 Bytes is a value wherein an FF2 RPR frame header length of 18 Bytes is subtracted from the 9216 Bytes which is JUMBO_MAX in FIG. 13A.

As described above, there has been a disadvantage in that the shorter the frame length, the greater the overhead of the RPR frame header and GFP frame header, wherein the RPR network bandwidth cannot be effectively used.

### SUMMARY

Accordingly, the present invention has been made with consideration of the above-described problems with the traditional technique, and it is an object thereof to provide an effective use of an RPR network bandwidth.

According to a first aspect of the present invention, there is provided a station device which is capable of communicating with a second station device, wherein the station device affiliates a plurality of first remote station devices and the second station device affiliates a plurality of second remote station devices. The station device includes: a relation storage which stores relation information which indicates relation between the second station device and the second remote station device; a frame nester which nests a plurality of first discrete messages into a first bundle message on the basis of the relation information which is stored in the relation storage, wherein the first discrete message has been transmitted from the first remote station device to the second remote station device; a bundle message transmitter which transmits the first bundle message to the second station device; a frame extractor which extracts a second discrete message which is nested in a second bundle message which has been transmitted from the second station device, wherein the second discrete message has been transmitted from the second remote station device to the first remote station device; and a discrete message transmitter which transmits the second discrete message to the first remote station device.

The station device and the second station device are preferably included in a Resilient Packet Ring network, wherein the first discrete message and the second discrete message are Ethernet frames, and the first bundle message and the second bundle message are RPR frames.

The frame nester of the station device may append IFG information and length information to the Ethernet frame, wherein the IFG information is for restoring Inter Frame Gap and the length information indicates an amount of data of the Ethernet frame which is nested in the RPR frame. In this configuration, the frame extractor may extract the Ethernet frame which is nested in the RPR frame on the basis of the length information and regulate each gap between successive Ethernet frames which are transmitted by the discrete message transmitter on the basis of each Inter Frame Gap which is restored from the IFG information.

The frame nester of the station device may delete a Frame Check Sequence from each Ethernet frame and insert a first Frame Check Sequence for whole of the nested Ethernet frames into the RPR frame. In this configuration, the frame extractor may check the nested Ethernet frames on the basis of a second Frame Check Sequence which is inserted into the RPR frame.

The Ethernet frames may be classified into a plurality of classes. In that case, the frame nester of the station device may exclusively nest Ethernet frames of specific classes.

The frame nester of the station device may exclusively nest Ethernet frames which have been addressed to remote station devices which are affiliated with specific station devices.

The frame nester of the station device may nest Ethernet frames which have been received within a predetermined amount of time.

The frame nester of the station device may nest Ethernet frames whose total amount of data exceeds a predetermined amount of data.

The relation storage of the station device may store the Ethernet frames in a classified section for each second station device. In this configuration, the frame nester may nest Ethernet frames which share the classified section.

The frame nester of the station device may extract Ethernet frames passing through a congested domain on the way to the second station device and nest the extracted Ethernet frames.

According to a second aspect of the present invention, there is provided a message transfer method which is performed by a first station device which is capable of communicating with a second station device, wherein the first station device affiliates a plurality of first remote station devices and the second station device affiliates a plurality of second remote station devices. The message transfer method includes the steps of: storing relation information which indicates relation between the second station device and the second remote station device; nesting a plurality of first discrete messages into a first bundle message on the basis of the relation information which has been stored, wherein the first discrete message has been transmitted from the first remote station device to the second remote station device; transmitting the first bundle message to the second station device; extracting a second discrete message which is nested in a second bundle message which has been transmitted from the second station device, wherein the second discrete message has been transmitted from the second remote station device to the first remote station device; and transmitting the second discrete message to the first remote station device.

According to a third aspect of the present invention, there is provided a program storage medium which is readable by a computer, wherein the program storage medium stores a program of instructions for the computer for executing a message transfer method, the computer is capable of communicating with a second station device, the computer affiliates a plurality of first remote station devices, and the second station device affiliates a plurality of second remote station devices. The message transfer method includes the steps of: storing relation information which indicates relation between the second station device and the second remote station device; nesting a plurality of first discrete messages into a first bundle message on the basis of the relation information which has been stored, wherein the first discrete message has been transmitted from the first remote station device to the second remote station device; transmitting the first bundle message to the second station device; extracting a second discrete message which is nested in a second bundle message which has been transmitted from the second station device, wherein the second discrete message has been transmitted from the second remote station device to the first remote station device; and transmitting the second discrete message to the first remote station device.

### BRIEF DESCRIPTION OF THE DRAWINGS

FIGS. 1A-1C are diagrams for describing an overview and the features of a station device according to a first embodiment of the present invention;

FIG. 2 is a block diagram illustrating a configuration of the station device according to the first embodiment;

FIG. 3 is a diagram illustrating an example of the information stored by a correlating storing unit;

FIG. 4 is a flowchart illustrating the flow of transferring processing of a nested RPR frame;

FIG. 5 is a flowchart illustrating the flow of receiving processing of a nested RPR frame;

FIG. 6 is a diagram for describing a station device according to a second embodiment;

FIG. 7 is a diagram for describing the station device according to the second embodiment;

FIG. 8 is a diagram for describing a station device according to a third embodiment;

FIG. 9 is a diagram for describing a station device according to a fourth embodiment;

FIG. 10 is a diagram for describing a station device according to a fifth embodiment;

FIGS. 11A and 11B are diagrams for describing a station device according to a sixth embodiment;

FIGS. 12A and 12B are diagrams for describing a traditional RPR network;

FIG. 13A is a diagram illustrating a data frame size of an RPR frame;

FIG. 13B is a diagram illustrating an FF1 frame format;

FIG. 13C is a diagram illustrating an FF2 frame format;

FIG. 13D is a diagram illustrating an STS-Nc SPE; and

FIGS. 13E-13G are diagrams illustrating calculation results of Ethernet capacity.

### DESCRIPTION OF THE PREFERRED EMBODIMENTS

Embodiments of the station device according to the present invention will be described in detail with reference to the appended drawings. Note that in the description below, an overview of the station device according to a first embodiment and features thereof, the configuration and process flow of the station device according to the first embodiment, and the advantages of the first embodiment will be described in sequence, following which other embodiments will be described.

### First Embodiment

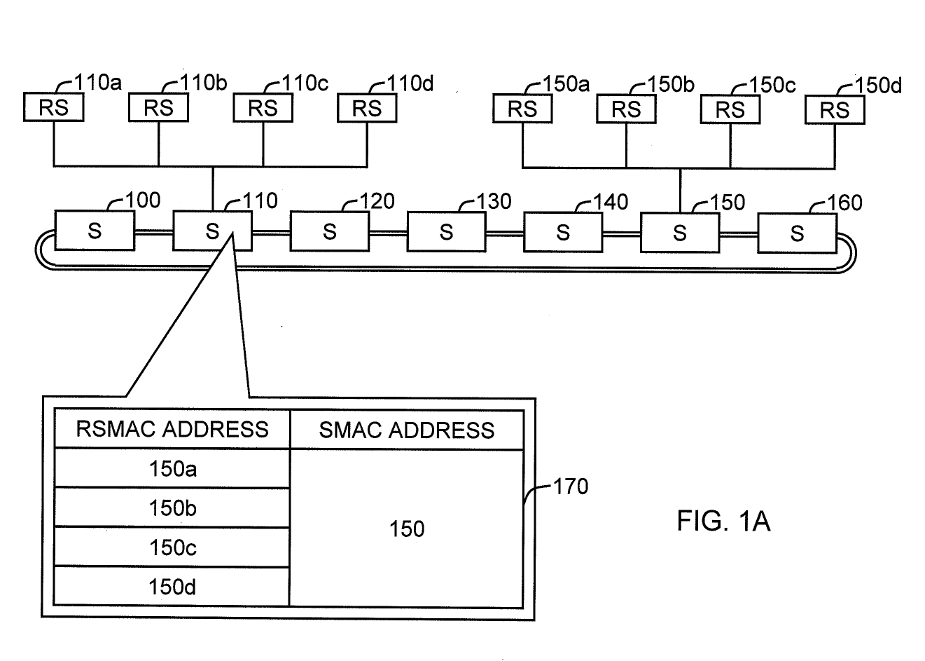

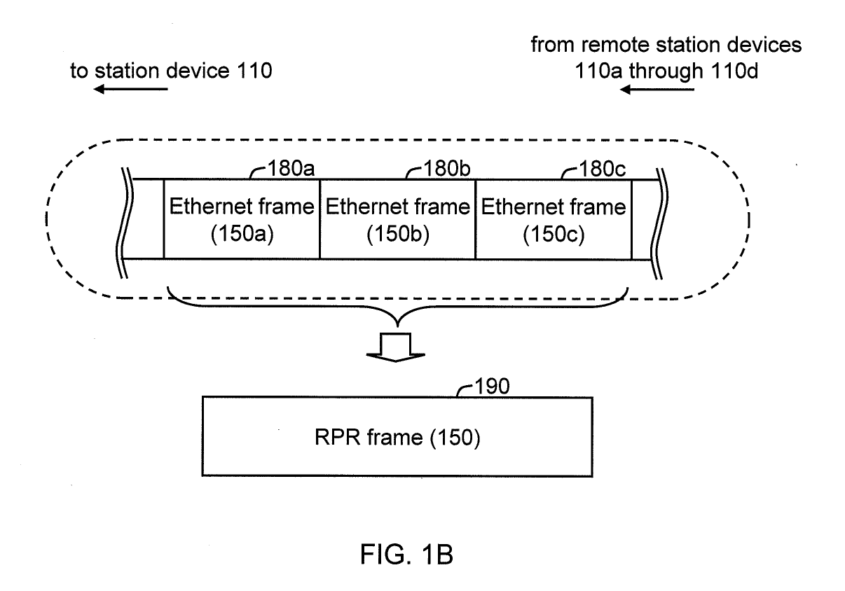

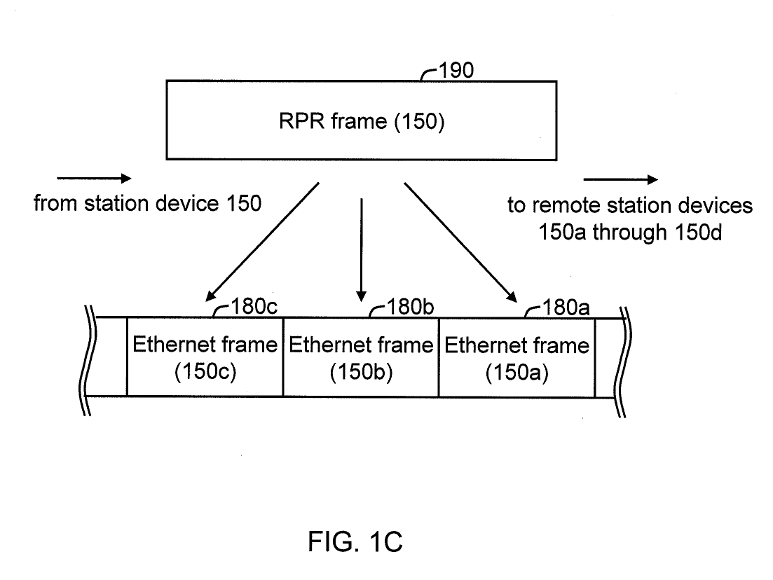

First, an overview and features of a station device according to a first embodiment will be described with reference to FIGS. 1A-1C. FIGS. 1A-1C are diagrams for describing the overview and features of a station device according to the first embodiment of the present invention.

An overview of the station device according to the first embodiment will be described below. As shown in FIG. 1A, a station device 110 constitutes an RPR network along with another station device 100 and station device 120 through station device 160 while affiliating remote station devices 110a through 110d. The station device 110 converts Ethernet frames received from the remote station devices 110a through 110d into RPR frames, and transfers these to an adjacent station device 100 or station device 120, while converting RPR frames addressed to the own station which are transferred from the adjacent station device 100 or station device 120 into Ethernet frames and transfer these to the affiliating remote station devices 110a through 110d. The above description is an overview of the station device according to the first embodiment, wherein the main feature of the station device is in enabling an RPR network bandwidth to be effectively used.

To describe this main feature, the station device 110 stores the correspondence relation between the MAC (Media Access Control) of another station device consisting the RPR network and the MAC address of remote station devices affiliated with this other station device.

To describe with a specific example, as shown in FIG. 1A, of the station devices 100 through 160 consisting the RPR network, the station device 150 affiliates the remote station devices 150a through 150d, so the station device 110 stores the correspondence relation between the MAC address of the station device 150 and the MAC addresses of the affiliating remote station devices 150a through 150d in a table 170.

When converting received Ethernet frames into RPR frames, the station device 110 then nests the Ethernet frames together which are addressed to the remote station devices affiliated with a shared station device, based on the stored correspondence relation and the transmission destination address of the Ethernet frame.

To describe with a specific example, as shown in FIG. 1B, the station device 110 receives various Ethernet frames 180 with different transmission destination addresses from remote station devices 110a through 110d and stores these in a storage unit. From the Ethernet frames stored in the storage unit, based on the correspondence relation stored in the table 170, the station device 110 nests the Ethernet frames 180a through 180c which are addressed to the remote station devices affiliated with the shared station device 150, and converts the shared RPR header to an appended RPR frame 190. Note that the station device 110 maps the RPR frame 190 to a GFP frame in a predetermined format, and transfers the GFP frame to the station device 100 (since the hop number to the station device 150 is less in the counter-clockwise direction).

Also, when receiving a nested RPR frame from another station device, the station device 110 extracts each Ethernet frame from the RPR frame.

To describe with a specific example (hereafter, the station device 150 will be given as the main example instead of the station device 110), as shown in FIG. 1C, when receiving the RPR frame 190 which is nested by the station device 110 and transferred from the station device 160, the station device 150 extracts the Ethernet frames 180a through 180c from the RPR frame 190, and transmits these Ethernet frames to the remote station devices 150a through 150c corresponding to the respective transmission destination addresses.

Therefore, according to the station device, as in the above-mentioned main feature, the RPR network bandwidth can be effectively used. That is to say, by nesting a plurality of Ethernet frames when converting RPR frames, the occupancy rate of the RPR frame headers in the RPR network bandwidth can be suppressed, thereby enabling effective use of the RPR network bandwidth.

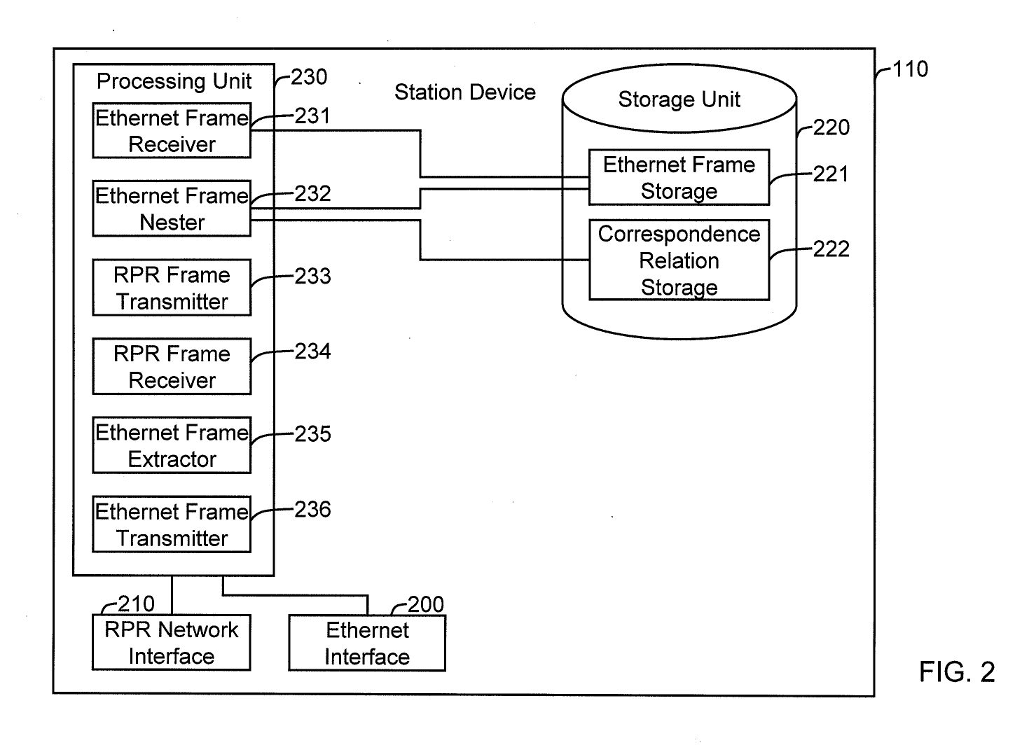

Next, the configuration of the station device according to the first embodiment shown in FIG. 1A will be described with reference to FIG. 2. FIG. 2 is a block diagram illustrating a configuration of the station device according to the first embodiment

As shown in FIG. 2, the station device 110 includes an Ethernet interface 200, an RPR interface 210, a storage unit 220, and a processing unit 230.

The Ethernet interface 200 controls communication between the own station and the affiliating remote station device. Specifically, the Ethernet interface 200 outputs the Ethernet frames received from the remote station devices 110a through 110d to an Ethernet frame receiver 231 of a processing unit 230 described later, and also transmits the Ethernet frames received from the Ethernet frame transmitter 236 of the processing unit 230 to the remote station devices 110a through 110d.

The RPR interface 210 controls communication between the own station and the other station devices constituting the RPR network. Specifically, when receiving a GFP frame transferred from an adjacent station device, the RPR interface 210 performs GFP de-capsulation on the GFP frame and extracts RPR frames from the GFP frame. The RPR interface 210 then takes in the RPR frames addressed to the own station and outputs them to the RPR frame receiver 234 of the processing unit 230. The RPR interface 210 performs GFP capsulation on the remaining RPR frames and transfers the new GFP frame to the next station device. When receiving the RPR frames from the RPR frame transmitter 233 of the processing unit 230, the RPR interface 210 performs GFP capsulation and transfers the new GFP frame to the adjacent station device. Note that the RPR interface 210 controls communication in the two paths formed in the clockwise direction and the counter-clockwise direction, respectively

The storage unit 220 stores data and programs necessary for various processing by the processing unit 230, and with regard to that which is closely related to the present invention in particular, the storage unit 220 has an Ethernet frame storage 221 and a correspondence relation storage 222. The Ethernet frame storage 221 stores the Ethernet frames until the Ethernet frames are converted into RPR frames. Specifically, the Ethernet frame storage 221 receives Ethernet frames from the Ethernet frame receiver 231, and stores the respective Ethernet frames until processed by an Ethernet frame nester 232 described later.

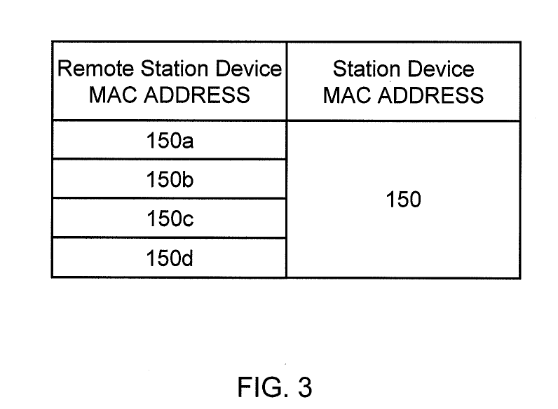

The correspondence relation storage 222 stores the correspondence relation between the MAC address of another station device constituting the RPR network and the MAC address of a remote station device affiliated with this other station device. FIG. 3 is a diagram illustrating an example of information stored in the correspondence relation storage 222. Hereafter, the reference numerals for the station devices and remote station devices will also be treated as the MAC addresses (for example, the MAC address for the station device 110 is “110”). As shown in FIG. 3, the correspondence relation storage 222 relates, for example, the MAC address “150a” of the remote station device 150a and the MAC address “150” of the station device 150.

The processing unit 230 has internal memory for storing control programs such as an OS (Operating System), programs with standards for various processing sequences and the like, and executes various processes, and with regard to that which is closely related to the present invention in particular, the processing unit 230 performs as an Ethernet frame receiver 231, an Ethernet frame nester 232, an RPR frame transmitter 233, an RPR frame receiver 234, an Ethernet frame extractor 235, and an Ethernet frame transmitter 236.

The Ethernet frame receiver 231 controls the reception of the Ethernet frames. Specifically, when receiving the Ethernet frames from the Ethernet interface 200, the Ethernet frame receiver 231 outputs the Ethernet frames to the Ethernet frame storage 221.

When converting the received Ethernet frames to RPR frames, the Ethernet frame nester 232 nests the Ethernet frames together which are addressed to remote stations affiliated with a shared station device, based on the stored correspondence relation and the transmission destination address of the Ethernet frames.

Specifically, the Ethernet frame nester 232 reads the transmission addresses of the Ethernet frames stored in the Ethernet frame storage 221 at a predetermined timing (for example, timing for receiving signals output at a fixed interval by a timer or the like), and also finds Ethernet frames addressed to remote station devices affiliated with a shared station device, on the basis of the correspondence relation stored in the correspondence relation storage 222.

The Ethernet frame nester 232 then performs nesting with the Ethernet frames addressed to remote station devices affiliated with a shared station device, and converts the nested Ethernet frames into an RPR frame by appending a new RPR header and FCS, and outputs the RPR frame to the RPR frame transmitter 233.

Even when Ethernet frames which are addressed to remote station devices affiliated with a shared station device are scattered in the Ethernet frame storage 221 instead of stored together, the Ethernet frame nester 232 converts the Ethernet frames into an RPR frame at the predetermined timing, and outputs the RPR frame to the RPR frame transmitter 233.

For example, the Ethernet frame nester 232 performs the following processing when the Ethernet frames stored in the Ethernet frame storage 221 have the transmission destination addresses of “150a”, “150b”, and “150c”. That is to say, on the basis of the correspondence relation stored in the correspondence relation storage 222, the Ethernet frame nester 232 knows these Ethernet frames correspond to the MAC address “150”, appends an RPR header including the transmission destination address “150” and the transmission source address “110” so as to convert to an RPR frame, and further appends a new FCS to the RPR frame.

The RPR frame transmitter 233 controls the transmission of the RPR frames. Specifically, when receiving an RPR frame from the Ethernet frame nester 232, the RPR frame transmitter 233 outputs the RPR frame to the RPR interface 210.

The RPR frame receiver 234 controls the reception of the RPR frames. Specifically, when receiving an RPR frame from the RPR interface 210, the RPR frame receiver 234 outputs the RPR frame to the Ethernet frame extractor 235.

When receiving an RPR frame nested by another station device, the Ethernet frame extractor 235 extracts each Ethernet frame from the RPR frame. Specifically, when receiving an RPR frame from the RPR frame receiver 234, the Ethernet frame extractor 235 extracts each Ethernet frame from the RPR frame and outputs the Ethernet frames to the Ethernet frame transmitter 236.

The Ethernet frame transmitter 236 controls transmission of the Ethernet frames. Specifically, when receiving an Ethernet frame from the Ethernet frame extractor 235, the Ethernet frame transmitter 236 outputs the Ethernet frame to the Ethernet interface 200.

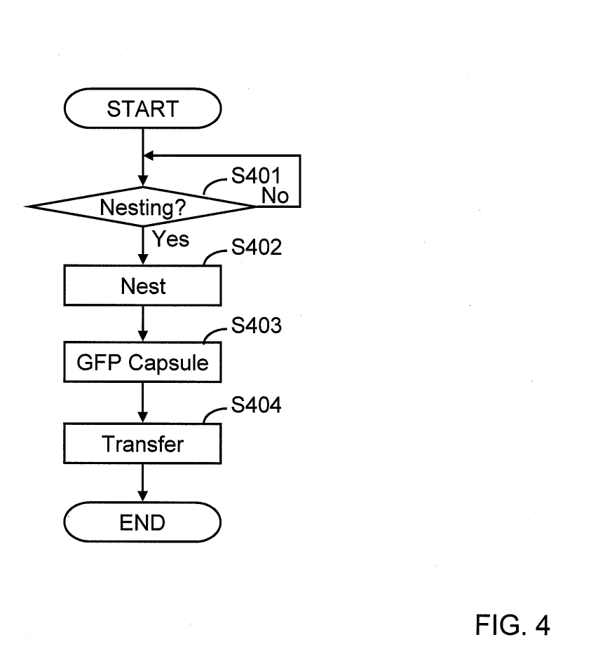

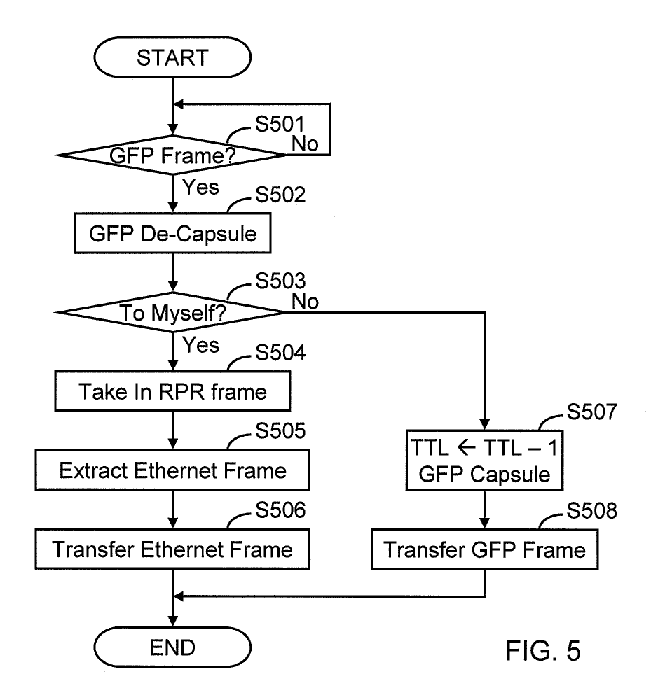

Next, processing by the station device according to the first embodiment will be described with reference to FIGS. 4 and 5. FIG. 4 is a flowchart illustrating the flow of transferring process of a nested RPR frame, and FIG. 5 is a flowchart illustrating the flow of receiving process of a nested RPR frame.

As shown in FIG. 4, in the station device 110, at the timing for performing nesting (Yes in step S401), the Ethernet frame nester 232 extracts Ethernet frames which are addressed to remote stations affiliated with a shared station device from the Ethernet frame storage 221, nests them, and converts them into an RPR frame (step S402). The RPR interface 210 receives the nested RPR frame from the Ethernet frame nester 232 via the RPR frame transmitter 233 and performs GFP capsulation (step S403). The RPR interface 210 then transfers the RPR frame to an adjacent station device (step S404).

Also, as shown in FIG. 5, in the station device 110, when receiving a GFP frame from an adjacent station device (Yes in step S501), the RPR interface 210 performs GFP de-capsulation (step S502). When the RPR frame is addressed to the own station device (Yes in step S503), the RPR interface 210 takes the RPR frame into the station device (step S504). Then the Ethernet frame extractor 235 extracts each Ethernet frame from the RPR frame received from the RPR interface 210 via the RPR frame receiver 234 (step S505). The Ethernet interface 200 transmits the Ethernet frames received from the Ethernet frame extractor 235 via the Ethernet frame transmitter 236 to the remote station device as the transmission destination (step S506).

When the RPR frame is not addressed to the own station device (No in step S503), the RPR interface 210 subtracts the TTL (Time To Live) by 1 and performs GFP capsulation (step S507). The RPR interface 210 then transfers the GFP frame to the next station device (step S508).

As described above, according to the first embodiment, the correspondence relation between the MAC address of another station device consisting the RPR network and the MAC address of a remote station device affiliated with this other station device is stored. When converting Ethernet frames into an RPR frame, Ethernet frames addressed to remote station devices affiliated with a shared station device are nested, on the basis of the correspondence relation and the transmission destination address of the Ethernet frames. When an RPR frame nested by another station device is received, each Ethernet frame is extracted from the RPR frame. By nesting a plurality of Ethernet frames when converting them into an RPR frame, the occupancy rate of the RPR frame header in the RPR network bandwidth may be suppressed. Therefore, the RPR network bandwidth may be used effectively.

Also, according to the first embodiment, those Ethernet frames are nested together when they are addressed to remote station devices affiliated with a shared station device and they are received from a remote station within a predetermined amount of time. Compared to a method in which nesting is performed when a total frame length exceeds a predetermined threshold, frame transferring may be effectively performed when fewer Ethernet frames are received.

### Second Embodiment

In the first embodiment, the received Ethernet frames are stored as they are into a buffer. In the second embodiment, the received Ethernet frames are appended with new information or stripped off unnecessary information when stored into the buffer.

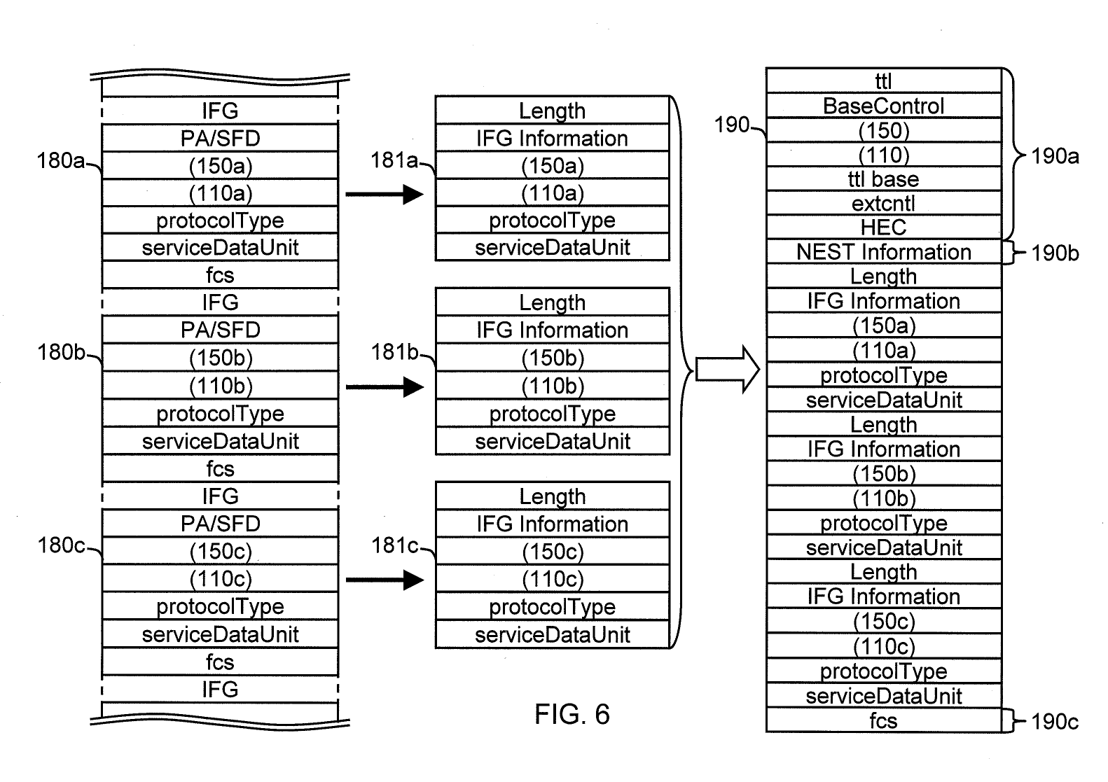

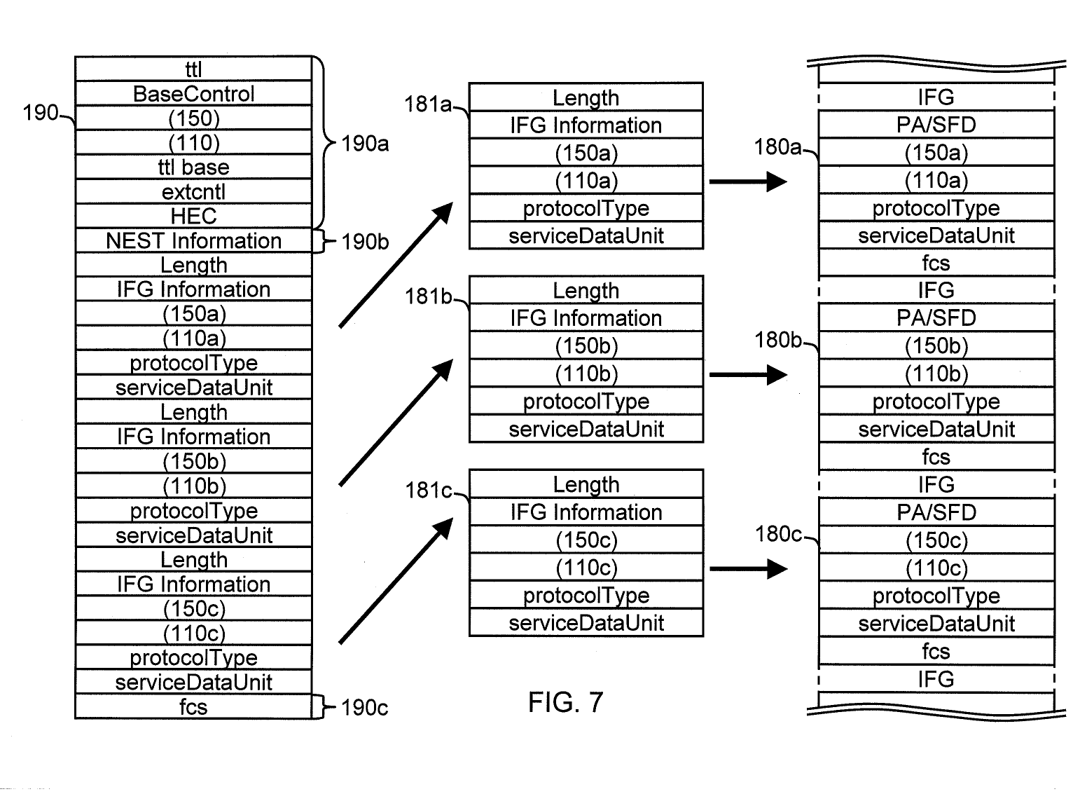

The station device 110 according to the second embodiment will be described with reference to FIGS. 6 and 7. FIGS. 6 and 7 are diagrams for describing the station device according to the second embodiment.

The station device 110 receives Ethernet frames consisting of four prominent sections of “PA (preamble)”, “MAC header”, “DATA”, and “FCS” with a predetermined IFG (Inter Frame Gap) spacing. Hereinafter, a specific portion of the last part of the PA will be distinguished and called as SFD (Start Frame Delimiter).

For example, as shown in FIG. 6, the station device 110 receives an Ethernet frame 180a wherein the transmission destination address included in the MAC header is “150a” and the transmission source address is “110a”, and after receiving a predetermined IFG, receives an Ethernet frame 180b wherein the transmission destination address included in the MAC header is “150b” and the transmission source address is “110b”, and further after receiving a predetermined IFG, receives an Ethernet frame 180c wherein the transmission destination address included in the MAC header is “150c” and the transmission source address is “110c”.

In the station device 110, the Ethernet frame receiver 231 deletes the PA/SFD from each of the Ethernet frames 180a through 180c and also deletes the FCS if there are no problems. Then the Ethernet frame receiver 231 generates Ethernet frames 181a through 181c by inserting IFG information and Length into the Ethernet frames 180a through 180c. The IFG information is resulted from converting the length of IFG into hexadecimal. The Length is resulted from converting the length of the MAC header and DATA into hexadecimal. The Ethernet frame receiver 231 stores the Ethernet frames 181a through 181c in the Ethernet frame storage 221.

The Ethernet frame nester 232 converts the Ethernet frames 181a through 181c into an RPR frame 190 by nesting the Ethernet frames 181a through 181c at a predetermined timing, appending an RPR header 190a which includes a transmission destination address “150” and a transmission source address “110”, inserting NEST information 190b for notifying the other station devices that these are nested frames after HEC (Header Error Checking) which is included in the RPR header 190a, and appending a new FCS 190c.

Next, a case will be described wherein the station device 150 receives a GFP frame, performs GFP de-capsulation, and, as shown in FIG. 7, the transmission destination address in the RPR header is “150” therefore the RPR frame 190 is taken in into the station device 150.

In the station device 150, the Ethernet frame extractor 235 identifies the RPR frame 190 as a nested RPR frame on the basis of the NEST information 190b. The Ethernet frame extractor 235 deletes the FCS 190c if there is no problem. The Ethernet frame extractor 235 extracts the Ethernet frames 181a through 181c on the basis of each Length, temporarily stores, in internal memory IFG computed on the basis of IFG information, and deletes the Length and IFG information. The Ethernet frame extractor 235 appends a PA/SFD and FCS to the Ethernet frames 181a through 181c, and outputs to the Ethernet frame transmitter 236 with a spacing of IFG stored in the internal memory.

As described above, according to the second embodiment, the IFG information for restoring IFG and the Length for extracting each Ethernet frame from the nested Ethernet frames are inserted between each of nested Ethernet frames. Each Ethernet frame is extracted on the basis of the Length inserted in the RPR frame, and also the spacing between each Ethernet frame is controlled on the basis of the IFG restored from the IFG information. Thus, Ethernet frames nested by another station device may be restored to the original Ethernet frames.

Also, according to the second embodiment, the FCS of Ethernet frames wherein no problems are found in the FCS check is deleted in the nesting process. Instead, an FCS check is performed on the basis of an FCS inserted into the RPR frame including the nested Ethernet frames. Thus, normality of Ethernet frames nested in another station device may be maintained.

### Third Embodiment

In a third embodiment, a case will be described wherein Ethernet frames to be nested are limited in accordance with service class.

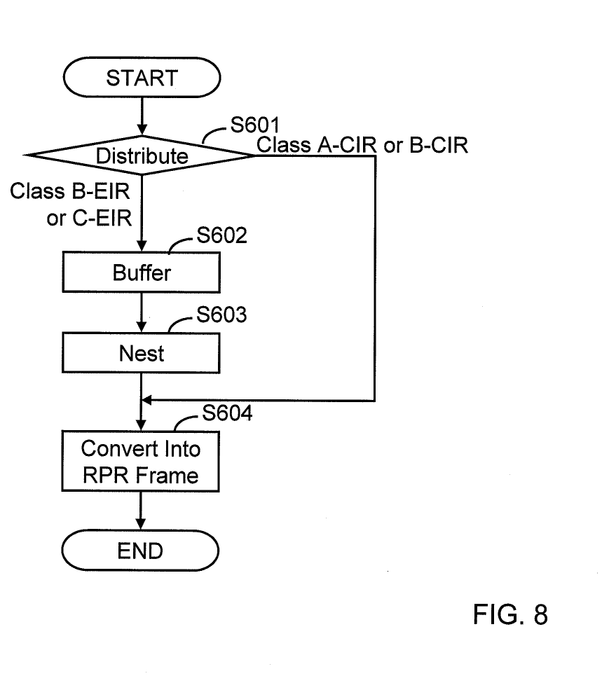

The station device 110 according to the third embodiment will be described with reference to FIG. 8. FIG. 8 is a diagram for describing the station device according to the third embodiment.

In RPR, Ethernet frames are divided into four service classes, which are Class A-CIR (Committed Information Rate), Class B-CIR, Class B-EIR (Excess Information Rate), and Class C-EIR. For example, the station device 110 may be arranged so as to exclusively nest Ethernet frames whose service class are Class B-EIR or Class C-EIR.

As shown in FIG. 8, in the station device 11, the Ethernet frame receiver 231 distributes the Ethernet frames in accordance with service class. Ethernet frames of Class A-CIR or Class B-CIR are output to the Ethernet frame nester 232, while the Ethernet frames of Class B-EIR or Class C-EIR are stored in the Ethernet frame storage 221 (step S601).

When receiving Ethernet frames of Class A-CIR or Class B-CIR from the Ethernet frame receiver 231, the Ethernet frame nester 232 converts the Ethernet frames into an RPR frame (step S604), and outputs to the RPR frame transmitter 233.

The Ethernet frame storage 221 stores the Ethernet frames of Class B-EIR or Class C-EIR, during the time until the Ethernet frames are converted into an RPR frame (step S602). The Ethernet frame nester 232 extracts and nests the Ethernet frames addressed to remote stations affiliated with a shared station device from the Ethernet frame storage 221 at a predetermined timing (step S603). The Ethernet frame nester 232 then converts the nested Ethernet frames into an RPR frame (step S604), and outputs the RPR frame to the RPR frame transmitter 233.

As described above, according to the third embodiment, Ethernet frames of predetermined service classes are nested so that frame transferring may be performed in accordance with service class. That is to say, nesting for only Ethernet frames of service classes of low priority, e.g. class B-EIR or class C-EIR, may be performed to control frame transferring. Thus, frame transferring may be performed in accordance with service class.

### Fourth Embodiment

With the fourth embodiment, a case will be described wherein the Ethernet frames to be nested are limited in accordance with destination station device.

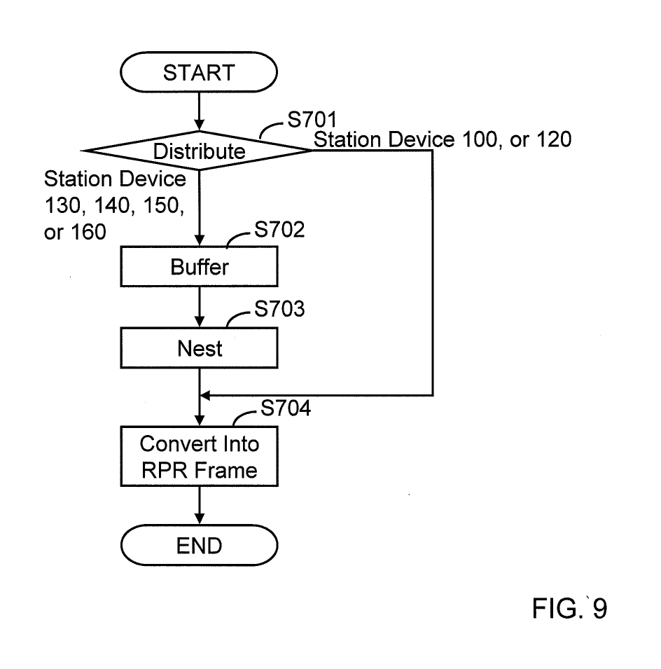

The station device 110 according to the fourth embodiment will be described. FIG. 9 is a diagram for describing the station device according to the fourth embodiment.

When an RPR network is consisted of station devices 100 through 160, for example, the station device 110 may be arranged so as to exclusively nest Ethernet frames having addresses of station device 130, station device 140, station device 150, or station device 160 as the transmission destination address.

As shown in FIG. 9, in the station device 110, the Ethernet frame receiver 231 distributes the Ethernet frames in accordance with destination station device. Ethernet frames having addresses of station device 100 or station device 120 as the transmission destination address are output to the Ethernet frame nester 232, while the Ethernet frames having addresses of station device 130 through 160 as the transmission destination address are stored in the Ethernet frame storage 221 (step S701). Specifically, when receiving the Ethernet frames from the Ethernet interface 200, the Ethernet frame receiver 231 retrieves the MAC address of the station device corresponding to the transmission destination address of the respective Ethernet frame in accordance with the correspondence relation stored in the correspondence relation storage 222. The Ethernet frame receiver 231 then performs distributing processing.

When receiving the Ethernet frames having addresses of station device 100 or station device 120 as the transmission destination address from the Ethernet frame nester 232, the Ethernet frames are converted into an RPR frame (step S704), and outputs the RPR frame to the RPR frame transmitter 233.

The Ethernet frame storage 221 stores Ethernet frames having addresses of station device 130 through 160 as the transmission destination address during the time until the Ethernet frames are converted into an RPR frame (S702). The Ethernet frame nester 232 extracts and nests the Ethernet frames addressed to remote stations affiliated with a shared station device from the Ethernet frame storage 221 at a predetermined timing (step S703). The Ethernet frame nester 232 then converts the nested Ethernet frames into an RPR frame (step S704), and outputs the RPR frame to the RPR frame transmitter 233.

As described above, according to the fourth embodiment, only Ethernet frames addressed to remote station devices affiliated with a predetermined station device are nested. Thus, limited storage capacity may be used effectively.

### Fifth Embodiment

In the first embodiment, all of the Ethernet frames are stored into one buffer. In the fifth embodiment, Ethernet frames are stored into buffers provided for each destination station device corresponding to the respective Ethernet frame.

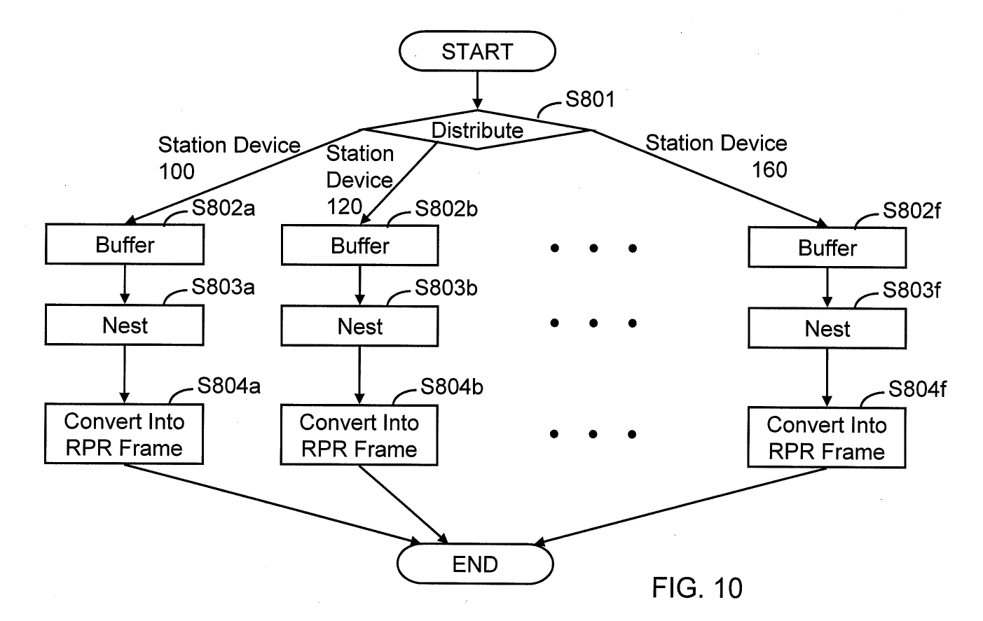

The station device 110 according to the fifth embodiment will be described with reference to FIG. 10. FIG. 10 is a diagram for describing the station device relating to the fifth embodiment.

When an RPR network is consisted of station devices 100 through 160, the station device 110 may be arranged to provide buffers for storing Ethernet frames addressed to each of six station devices which are the station device 100, station device 120, station device 130, station device 140, station device 150, and station device 160.

As shown in FIG. 10, in the station device 110, the Ethernet frame receiver 231 distributes the Ethernet frames in accordance with destination station device. The Ethernet frame receiver 231 then stores the Ethernet frames in the Ethernet frame storage 221 separately, that is, stores the Ethernet frames addressed to the station device 100 in the buffer 221a, stores the Ethernet frames addressed to the station device 120 in the buffer 221b, and so forth (step S801). Specifically, when receiving the Ethernet frames from the Ethernet interface 200, the Ethernet frame receiver 231 retrieves the MAC address of the station device corresponding to the transmission destination address of the respective Ethernet frame in accordance with the correspondence relation stored in the correspondence relation storage 222. The Ethernet frame receiver 231 then performs distributing processing.

The Ethernet frame storage 221 stores the Ethernet frames having addresses of station device 100 or station device 120 through 160 as the transmission destination address in each buffer during the time until the Ethernet frames are converted into an RPR frame (step S802). Then the Ethernet frame nester 232 extracts and nests the Ethernet frames stored in each buffer at a predetermined timing (step S803). The Ethernet frame nester 232 then converts the nested Ethernet frames into an RPR frame (step S804), and outputs the RPR frame to the RPR frame transmitter 233.

As described above, according to the fifth embodiment, the Ethernet frames are stored separately in accordance with destination station device of the RPR frame and the Ethernet frames stored together are nested. Thus, efficient nesting may be performed compared to storing all of the Ethernet frames in a shared buffer.

### Sixth Embodiment

In the sixth embodiment, a case will be described wherein only Ethernet frames which pass through a congested domain on the way to the destination station device from the own station are nested.

In RPR, station devices share information relating to congestion or obstruction occurring ahead of the own station by transmitting/receiving TP (Topology Protection) frames. Specifically, when receiving a TP frame, each station device writes the information relating to the congestion or obstruction into a topology database (a table storing the hop number from the own station to each station device along two paths which are the clockwise direction and the counter-clockwise direction). An arrangement may be that, in each station device, the Ethernet frames are nested only when the received Ethernet frames pass through a congested domain on the way to the destination station device.

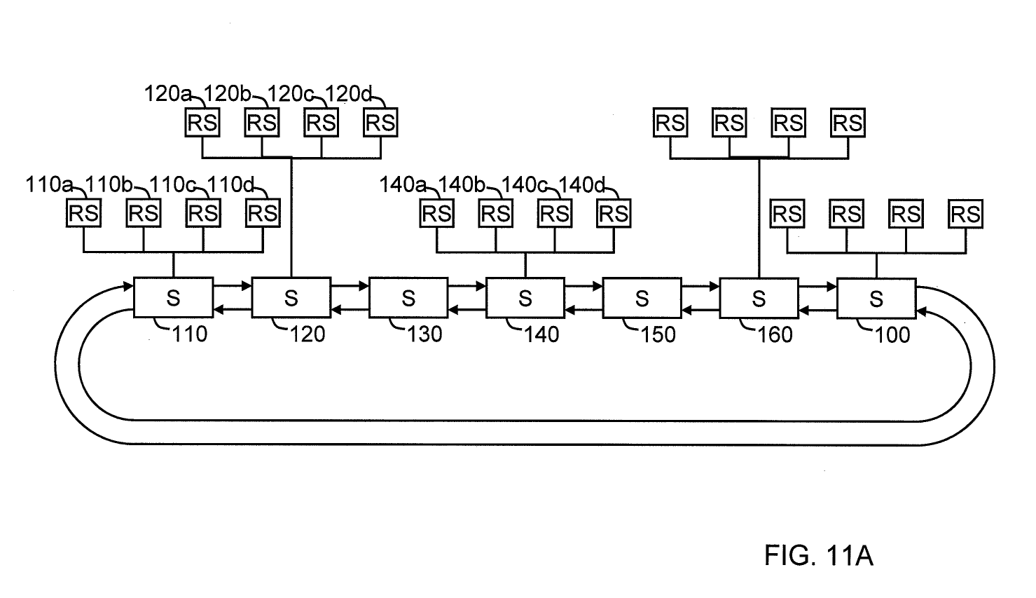

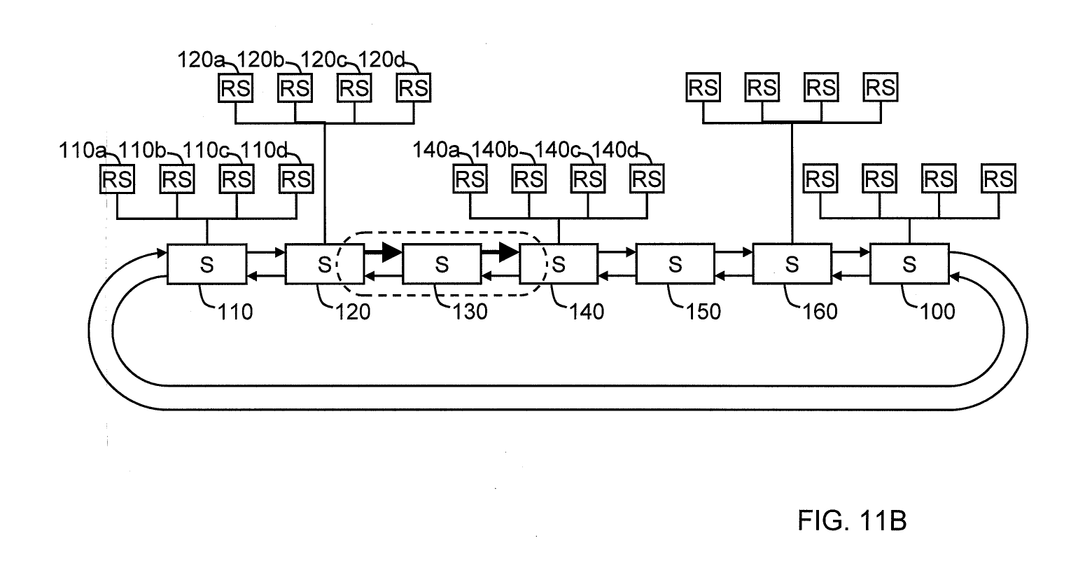

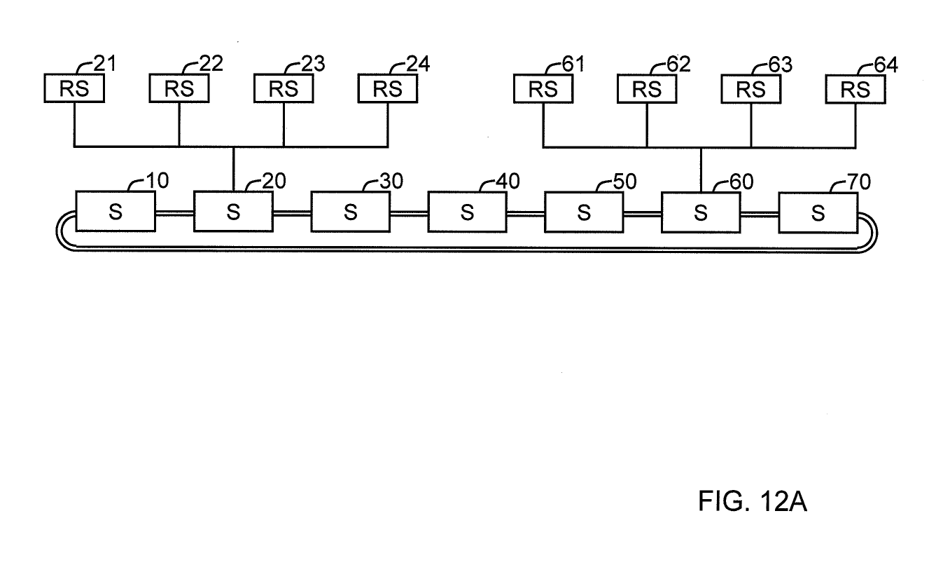

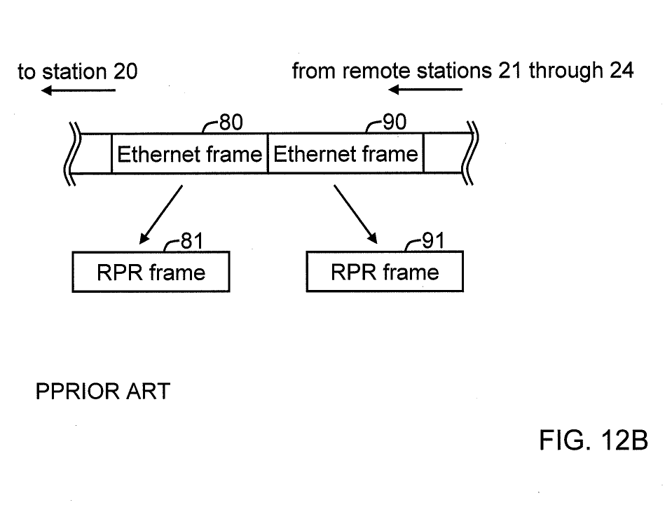

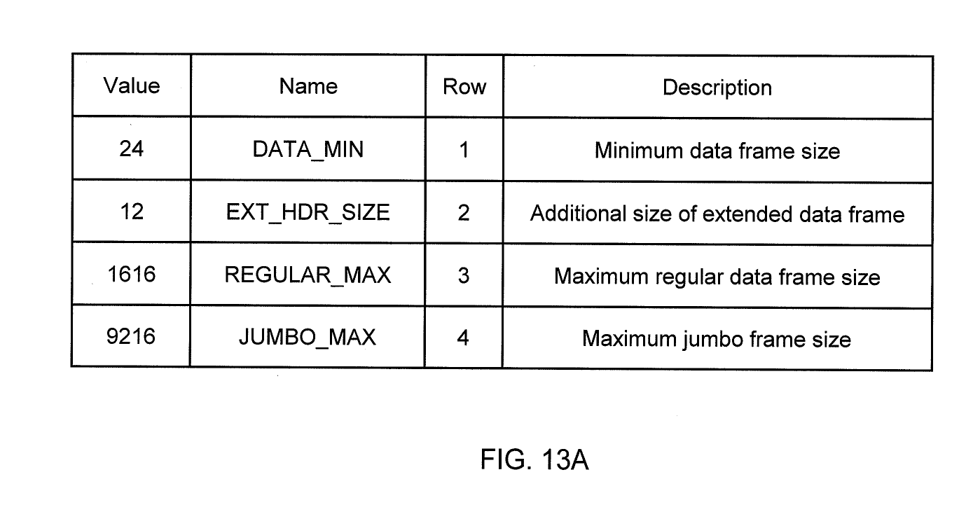

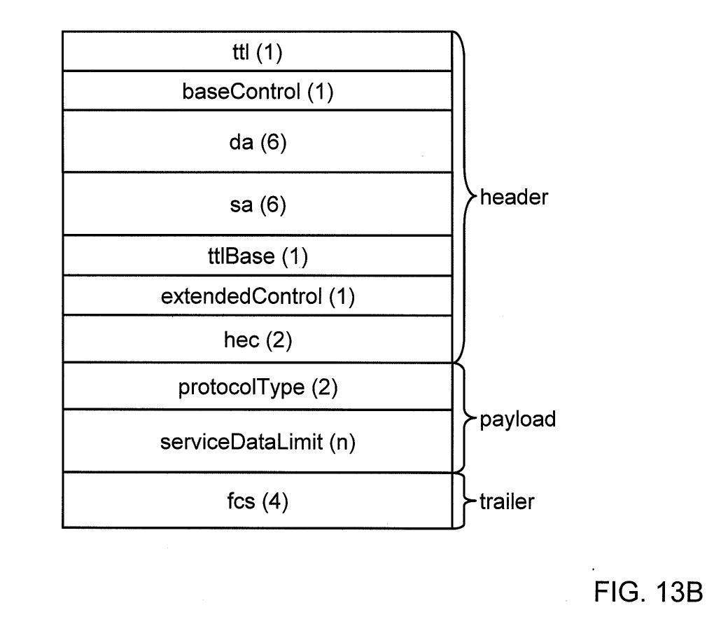

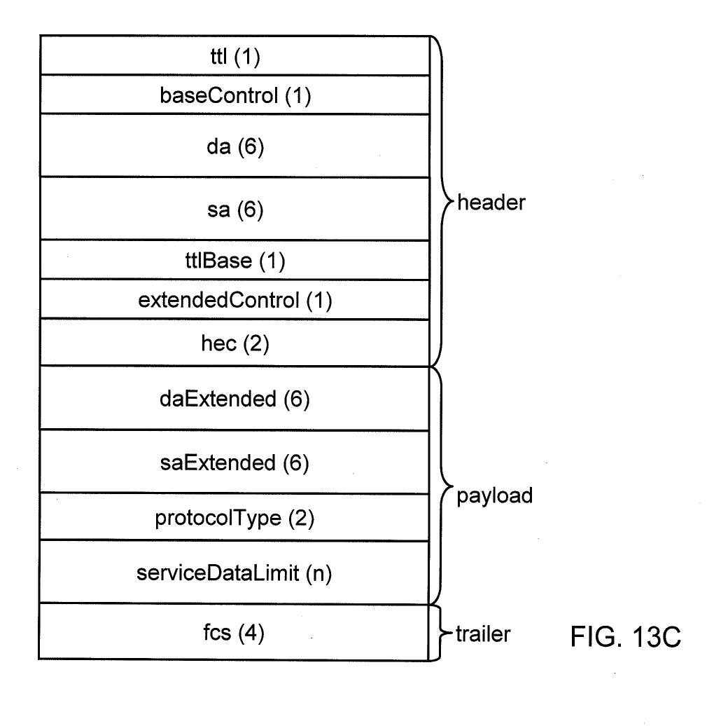

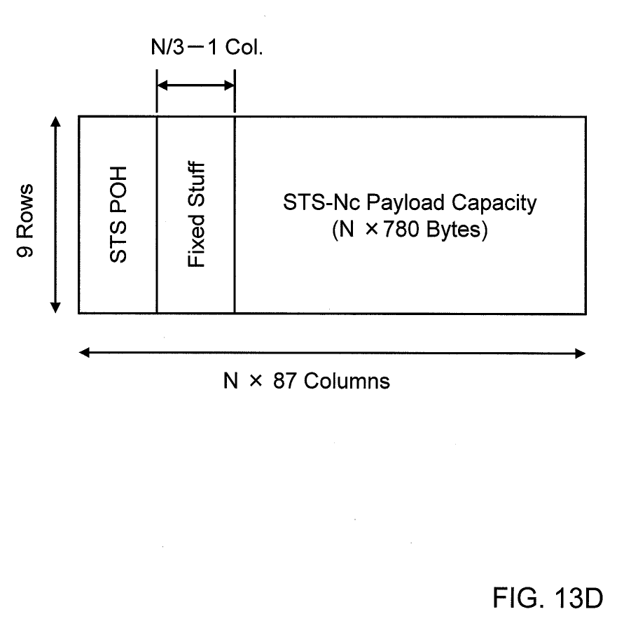

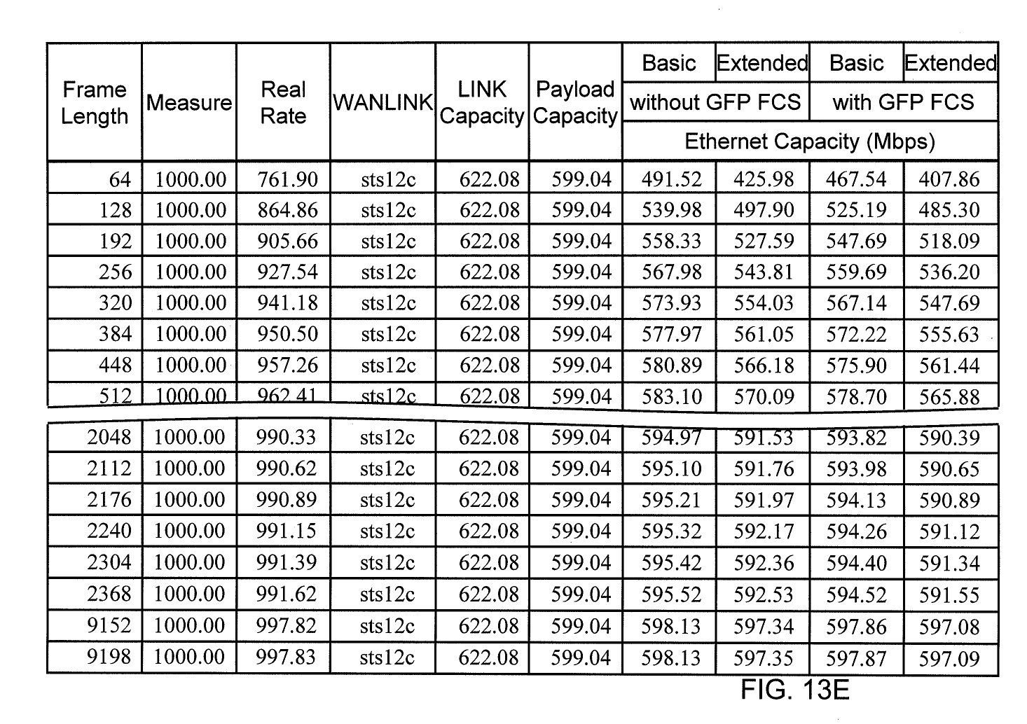

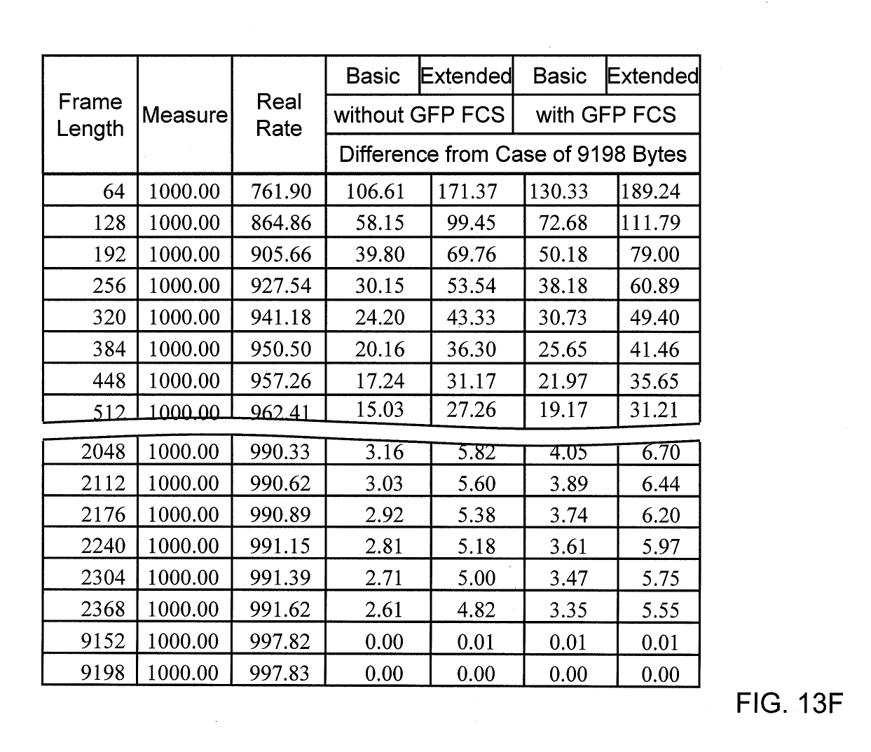

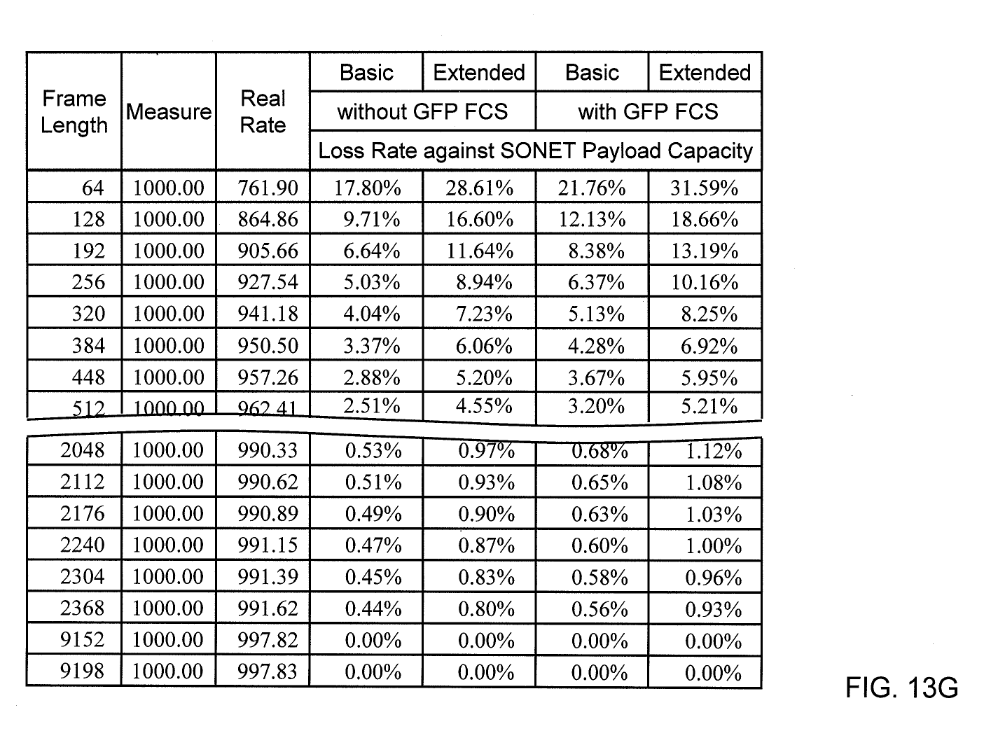

The station device 110 according to the sixth embodiment will be described with reference to FIGS. 11A and 11B. FIGS. 11A and 11B are diagrams for describing the station device according to the sixth embodiment.

As shown in FIG. 11A, the station device 110 constitutes an RPR network along with the station device 100 and the station devices 120 through 160 while affiliating remote station devices 110a through 110d. The station device 120 and station device 140 also affiliate remote station devices 120a through 120d and remote station devices 140a through 140d, respectively.

When receiving Ethernet frames addressed to remote station device 140d from remote station device 110b and selecting clockwise transferring in accordance with a topology database, the Ethernet frames do not pass through a congested domain. Therefore, the station device 110 converts these Ethernet frames individually to RPR frames and transfers them.

On the other hand, as shown in FIG. 11B, when receiving Ethernet frames addressed to remote station device 140d from remote station device 110b, the station device 110 and selecting clockwise transferring in accordance with a topology database, the Ethernet frames pass through a congested domain. Therefore, the station device 110 stores the Ethernet frames in the Ethernet frame storage 221 so as to be nested.

As described above, according to the sixth embodiment, only Ethernet frames which pass through a congested domain on the way to the destination station device from the own station are nested. Thus, delays yielded by excessive nesting may be regulated.

### Seventh Embodiment

Now, while embodiments according to the present invention have been described up to this point, the present invention may be carried out in the form of various differing embodiments other than the above-described embodiments. Thus, as shown below, differing embodiments will be described by general categorization into (1) and (2).

### (1) Nesting

In the first embodiment described above, Ethernet frames addressed to remote station devices affiliated with a shared station device are nested together when such Ethernet frames are received from a remote station within a predetermined timeframe. However, the present invention is not limited to this, and the Ethernet frames addressed to remote station devices affiliated with a shared station device may be nested together when the total frame length of the Ethernet frames to be nested exceeds a predetermined threshold.

For example, the Ethernet frame nester 232 may compute total frame length of Ethernet frames stored in the Ethernet frame storage 221 and addressed to remote station devices affiliated with a shared station device for all of the Ethernet frames, each time Ethernet frames are stored in the Ethernet frame storage 221. Then, the Ethernet frames whose total frame length is exceeding a predetermined threshold are nested together. The above-mentioned processing may be performed at the timing of receiving a signal output at fixed intervals by a timer or the like. Thus, compared to nesting each predetermined timeframe, frame transferring may be performed efficiently when a large number of Ethernet frames are received.

### (2) System Configuration

The components of the various devices shown in the diagrams are functional concepts, and are not necessarily configured physically as shown in the diagrams. That is to say, specific embodiments of how the various devices are scattered or integrated are not limited to those shown in the diagrams. All or part of a device may be configured by functionally or physically integrating with or separating from with arbitrary units, in accordance with each type of load or use situation, for example, integrating the Ethernet frame receiver 231 with the Ethernet frame nester 232. Further, all or an arbitrary portion of the various processing functions performed at the various devices can be realized with a CPU (Central Processing Unit) and a program to be loaded on the memory and executed by the CPU, or can be realized as hardware using wired logic.

Also, with regard to information including processing sequences, control sequences, specific names, and various types of data or parameters in the above-described document or in the diagrams, arbitrary changes may be made except for specified cases. For example, the reference numerals “110” or “110a” used for a MAC address is not limited to this, and may be any unique identifier of a station device or remote station device.

What is claimed is:

1. A station device capable of communicating with a second station device, said station device affiliating a plurality of first remote station devices, said second station device affiliating a plurality of second remote station devices, said station device comprising
a relation storage for storing relation information indicating relation between the second station device and the second remote station device;
a frame nester for nesting a plurality of first discrete messages into a first bundle message on the basis of the relation information stored in the relation storage, said first discrete message being transmitted from the first remote station device to the second remote station device;
a bundle message transmitter for transmitting the first bundle message to the second station device;
a frame extractor for extracting a second discrete message nested in a second bundle message transmitted from the second station device, said second discrete message being transmitted from the second remote station device to the first remote station device; and
a discrete message transmitter for transmitting the second discrete message to the first remote station device.

2. The station device of claim 1, wherein
said station device and said second station device are included in a Resilient Packet Ring network,
said first discrete message and said second discrete message are Ethernet frames, and
said first bundle message and said second bundle message are RPR frames.

3. The station device of claim 2, wherein
said frame nester appends IFG information and length information to the Ethernet frame, said IFG information being for restoring Inter Frame Gap, said length information being for indicating an amount of data of the Ethernet frame nested in the RPR frame, and
said frame extractor extracts the Ethernet frame nested in the RPR frame on the basis of the length information and regulates each gap between successive Ethernet frames transmitted by the discrete message transmitter on the basis of each Inter Frame Gap restored from the IFG information.

4. The station device of claim 2, wherein
said frame nester deletes a Frame Check Sequence from each Ethernet frame and inserts a first Frame Check Sequence for whole of the nested Ethernet frames into the RPR frame, and
said frame extractor checks the nested Ethernet frames on the basis of a second Frame Check Sequence inserted into the RPR frame.

5. The station device of claim 2, wherein
said Ethernet frames are classified into a plurality of classes, and
said frame nester exclusively nests Ethernet frames of specific classes.

6. The station device of claim 2, wherein
said frame nester exclusively nests Ethernet frames addressed to remote station devices affiliated with specific station devices.

7. The station device of claim 2, wherein
said frame nester nests Ethernet frames received within a predetermined amount of time.

8. The station device of claim 2, wherein
said frame nester nests Ethernet frames whose total amount of data exceeds a predetermined amount of data.

9. The station device of claim 2, wherein
said relation storage stores the Ethernet frames in a classified section for each second station device, and
said frame nester nests Ethernet frames sharing the classified section.

10. The station device of claim 2, wherein
said frame nester extracts Ethernet frames passing through a congested domain on the way to the second station device and nests the extracted Ethernet frames.

11. A message transfer method performed by a first station device capable of communicating with a second station device, said first station device affiliating a plurality of first remote station devices, said second station device affiliating a plurality of second remote station devices, said message transfer method comprising the steps of
storing relation information indicating relation between the second station device and the second remote station device;
nesting a plurality of first discrete messages into a first bundle message on the basis of the relation information stored, said first discrete message being transmitted from the first remote station device to the second remote station device;
transmitting the first bundle message to the second station device;
extracting a second discrete message nested in a second bundle message transmitted from the second station device, said second discrete message being transmitted from the second remote station device to the first remote station device; and
transmitting the second discrete message to the first remote station device.

12. A program storage medium readable by a computer, said program storage medium storing a program of instructions for the computer for executing a message transfer method, said computer being capable of communicating with a second station device, said computer affiliating a plurality of first remote station devices, said second station device affiliating a plurality of second remote station devices, said message transfer method comprising the steps of:
storing relation information indicating relation between the second station device and the second remote station device;
nesting a plurality of first discrete messages into a first bundle message on the basis of the relation information stored, said first discrete message being transmitted from the first remote station device to the second remote station device;
transmitting the first bundle message to the second station device;
extracting a second discrete message nested in a second bundle message transmitted from the second station device, said second discrete message being transmitted from the second remote station device to the first remote station device; and
transmitting the second discrete message to the first remote station device.
